(19) United States
(12) Patent Application Publication
(10) Pub. No.: US 2021/0358262 A1
(43) Pub. Date: Nov. 18, 2021

(54) MEDIUM, SERVER DEVICE, AND METHOD

(71) Applicant: SQUARE ENIX CO., LTD., Tokyo (JP)

(72) Inventor: Makoto TSUDA, Tokyo (JP)

(73) Assignee: SQUARE ENIX CO., LTD., Tokyo (JP)

(21) Appl. No.: 17/319,843

(22) Filed: May 13, 2021

(30) Foreign Application Priority Data
May 14, 2020 (JP) 2020-084926

(51) Int. Cl. G07F 17/32; G06T 19/00; A63F 13/79; A63F 13/57

(52) U.S. Cl. CPC G07F 17/3211; G06T 19/006; G07F 17/329; A63F 13/57; A63F 13/79

(57) ABSTRACT

A server device transmits drawing data for drawing a product to a user terminal, grants display authority to display the drawing data of the product and is limited to a predetermined time period, to a non-winning user who does not win the product, performs a lottery for a product in response to a lottery request from the user terminal, outputs an instruction for delivering a physical product won as a result of the lottery to a predetermined place corresponding to a user, and grants display authority to display the drawing data of a product won as a result of the lottery and is not limited to the predetermined time period, to a winning user.

### CROSS-REFERENCE TO RELATED APPLICATION(S)

This application claims priority to and the benefit of Japanese Patent Application No. 2020-084926, filed on May 14, 2020, the disclosure of which is expressly incorporated herein by reference in its entirety for any purpose.

### FIELD

At least one of embodiments of the present disclosure relates to a program, a server device, and a method for performing a lottery for a product.

### BACKGROUND

Conventionally, there is proposed a virtual capsule toy game method in which a mobile terminal displays a plurality of toy spots within a predetermined area on a map on a mobile terminal screen by using map drawing information based on position information and using position information of the toy spots, and when a specific toy spot is selected from among the plurality of displayed toy spots by using a finger contact operation function by a user, a virtual capsule toy with a rotary handle of the specific toy spot is displayed on the mobile terminal screen, and when a handle rotation operation is performed by the user, a game server is instructed to perform a lottery for a capsule toy at the specific toy spot, a plurality of prize IDs at the specific spot received by the game server are extracted from a correspondence information table, one prize ID is selected from among the plurality of extracted prize IDs and is transmitted to the mobile terminal, and an actual capsule toy is delivered to the user. Examples of such method may be found in Japanese Patent Application Publication No. 2020-011004.

In addition, there is proposed a technique capable of obtaining a prize having two-dimensional bar code print or an embedded RFID tag by playing a crane game, and obtaining information sent from the two-dimensional bar code or the RFID tag of the prize when a game is played with a driving game for business or a mobile phone game device, and capturing the information on the prize into a virtual space in the game, and using the prize as an ornament or the like in the virtual space. Example of such technique may be found in Japanese Patent Application Publication No. 2012-254217.

### SUMMARY

Conventionally, a service in which the user wins a product according to a lottery result is provided. However, in such a service, an actual product is exhibited in order to allow the user to check a product which can be won and, therefore, product rollout has been restricted. On the other hand, conventionally, by providing drawing data of a product before being purchased to those who wish to purchase the product, they are allowed to check details of the product (e.g., there is a method which uses a technique of what is called augmented reality (Hereinafter simply referred to as “AR”)). However, in the case where drawing data of a product is provided to a consumer which has not purchased the product, a consumer's desire to possess the product is partially satisfied, and sale of the product may be affected.

An object of at least one of embodiments of the present disclosure is to solve the above problem and reduce restrictions on product rollout without spoiling convenience or buying motivation of a consumer in a service in which a product is won via a lottery.

According to a non-limiting aspect, an aspect of the present disclosure is a server device comprising: a product database which stores identification information of a physical product and drawing data for drawing the product in association with each other; a memory; and a processor coupled to the memory, the processor being configured to execute: acquiring the drawing data from the product database and transmitting the drawing data to a user terminal; granting display authority, which relates to the drawing data of the product and is limited to a predetermined time period, to a non-winning user who does not win the product; performing a lottery for a product in response to a lottery request from the user terminal; outputting an instruction for delivering a physical product won as a result of the lottery to a predetermined place corresponding to a user; and granting display authority, which relates to the drawing data of a product won as a result of the lottery and is not limited to the predetermined time period, to a winning user.

In addition, according to a non-limiting aspect, an aspect of the present disclosure can be viewed as a program for causing a computer connected to a display device to execute: acquiring, from a server device, identification information of a physical product and drawing data for drawing the product; acquiring, from the server device, display authority, which relates to the drawing data of a product which is not won and is limited to a predetermined time period; generating an image including a product image drawn on the basis of the drawing data; outputting the image to the display device; transmitting a lottery request of the product to the server device; and acquiring, from the server device, display authority, which relates to the drawing data of a product won as a result of a lottery performed in response to the lottery request and is not limited to the predetermined time period.

Note that the present disclosure can be grasped as an information processing device, an information processing system, a method executed by a computer, or a program which a computer is caused to execute. In addition, the present disclosure can also be grasped as such a program which is recorded in a recording medium which can be read by a computer and other devices and machines. Herein, the recording medium which can be read by the computer and the like denotes a recording medium which stores information such as data or a program by an electric, magnetic, optical, mechanical, or chemical operation and allows reading of the information from the computer and the like.

Each of the embodiments of the present application solves one or more deficiencies.

### BRIEF DESCRIPTION OF THE DRAWINGS

FIG. 1 is a view showing the outline of the functional configuration of a server device corresponding to at least one of embodiments of the present disclosure;

FIG. 2 is a flowchart showing the procedure of server device-side processing corresponding to at least one of the embodiments of the present disclosure;

FIG. 3 is a view showing the outline of the functional configuration of the server device corresponding to at least one of the embodiments of the present disclosure;

FIG. 4 is a flowchart showing the procedure of the server device-side processing corresponding to at least one of the embodiments of the present disclosure;

FIG. 5 is a view showing the outline of the functional configuration of the user device corresponding to at least one of the embodiments of the present disclosure;

FIG. 6 is a flowchart showing the procedure of user device-side processing corresponding to at least one of the embodiments of the present disclosure;

FIG. 7 is a view showing the outline of the functional configuration of the user device corresponding to at least one of the embodiments of the present disclosure;

FIG. 8 is a flowchart showing the procedure of the user device-side processing corresponding to at least one of the embodiments of the present disclosure;

FIG. 9 is a view showing the outline of the configuration of an information processing system corresponding to at least one of the embodiments of the present disclosure;

FIG. 10 is a view showing the outline of the functional configuration of the information processing system corresponding to at least one of the embodiments of the present disclosure;

FIGS. 11A and 11B are sequence diagrams showing the procedure of lottery event processing corresponding to at least one of the embodiments of the present disclosure;

FIG. 12 is a view showing a user terminal in which an image (rotatable display screen) corresponding to at least one of the embodiments of the present disclosure is displayed;

FIG. 13 is a view showing the user terminal in which the image (AR display screen) corresponding to at least one of the embodiments of the present disclosure is displayed; and

FIG. 14 is a view showing the user terminal in which a lottery direction screen corresponding to at least one of the embodiments of the present disclosure is displayed.

### DESCRIPTION OF EMBODIMENTS

Hereinbelow, embodiments of the present disclosure will be described with reference to the drawings. Note that each embodiment described below shows an example in the case where the present disclosure is carried out, and the present disclosure is not limited to specific configurations described below. When the present disclosure is carried out, the specific configuration corresponding to the embodiment may be appropriately adopted.

In addition, various components in an example of each embodiment described below can be appropriately combined as long as no contradiction arises. Further, there are cases where the description of details described as an example of a given embodiment is omitted in other embodiments. In addition, there are cases where details of operations and processing which are not related to characteristic portions of each embodiment are omitted. Further, the order of various steps of processing constituting various procedures described below is not fixed as long as no contradiction arises in details of the processing.

First Embodiment

### Device Configuration

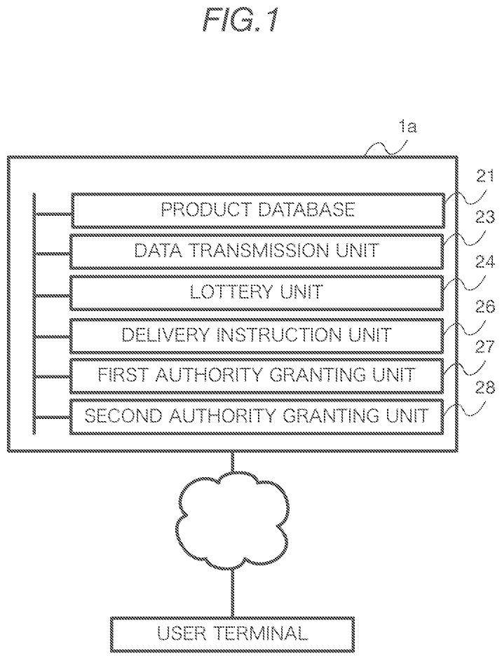

FIG. 1 is a view showing the outline of the functional configuration of a server device 1a according to the present embodiment. A processor interprets and executes various programs loaded into various memories, and the server device 1a according to the present embodiment thereby functions as an information processing device including a product database 21, a data transmission unit 23, a lottery unit 24, a delivery instruction unit 26, a first authority granting unit 27, and a second authority granting unit 28. In the present embodiment, a description will be given of an example in which these functions are executed by a general-purpose processor, but part or all of these functions may also be implemented by one or a plurality of dedicated processors. In addition, the individual functional units provided in the server device 1a may be installed remotely and/or in a distributed manner (e.g., on a cloud). Further, these functional units may also be implemented not by a single software module but by a plurality of software modules.

The product database 21 stores identification information of a physical product (tangible product) and drawing data for drawing the product in association with each other. Herein, the drawing data is three-dimensional model data (hereinafter simply referred to as “3D model data”) with which an image when an object is viewed from any direction can be generated by disposing the object in a virtual space and imaging the object with a virtual camera.

The data transmission unit 23 acquires the drawing data from the product database 21 and transmits the drawing data to a user terminal.

The lottery unit 24 performs a lottery for the product in response to a lottery request from the user terminal. The lottery is performed by, e.g., generating random numbers, and an identifier of the product won by a user is output as a lottery result.

The delivery instruction unit 26 outputs an instruction for delivering the physical product won as a result of the lottery to a predetermined place corresponding to the user. Note that, in other embodiments described later, an example in which the delivery destination of the product is a store will be described, but the delivery destination of the product is not limited to the store. For example, the product may also be delivered to a residence (a home or an office) of the user.

The first authority granting unit 27 grants display authority which relates to the drawing data of the product and is limited to a predetermined time period to a non-winning user who has not yet won the product.

The second authority granting unit 28 grants display authority which relates to the drawing data of the product won as a result of the lottery, and is not limited to a predetermined time period to a winning user.

Processing Procedure

Next, the procedure of processing executed in the present embodiment will be described. Note that the specific details and processing order of the processing shown in a flowchart according to the embodiment are examples for carrying out the present disclosure. The specific processing details and the processing order may be appropriately selected according to the embodiment of the present disclosure.

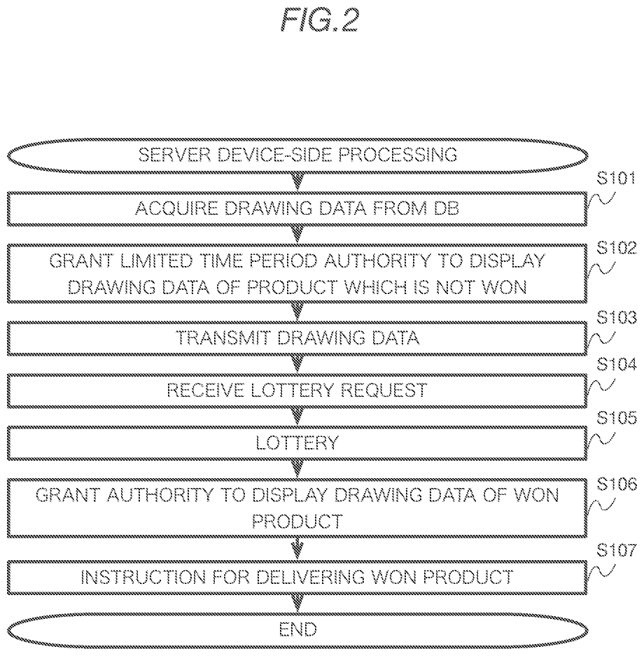

FIG. 2 is a flowchart showing the procedure of server device-side processing according to the first embodiment. The processing shown in the present flowchart is executed upon reception of a request for the drawing data of the product transmitted by the user terminal.

From Step S101 to Step S103, granting of the display authority which relates to the drawing data and data transmission to the user terminal are performed. The data transmission unit 23 acquires the drawing data of the product from the product database 21 (Step S101), and the first authority granting unit 27 grants the display authority which relates to the drawing data of the product and is limited to the predetermined time period to the non-winning user (Step S102). Subsequently, the server device 1a transmits the drawing data acquired from the product database 21 and information for granting the display authority which relates to the drawing data to the user terminal (Step S103). Thereafter, the processing proceeds to Step S104.

In Step S104 and Step S105, the lottery for the product is performed. When the lottery request transmitted from the user terminal is received (Step S104), the lottery unit 24 performs the lottery for the product (Step S105). Note that the lottery performed by the lottery unit 24 may be a lottery in which any product is always won or may also be a lottery in which the product may not be won. In the case where no product is won by the lottery, the processing shown in the present flowchart is ended. In the case where any product is won by the lottery, the processing proceeds to Step S106.

In Step S106 and Step S107, granting of the display authority which relates to the drawing data of the won product, and arrangements for the dispatch of the won product are performed. When the product is won as a result of the lottery, the second authority granting unit 28 grants the display authority which relates to the drawing data of the product won as a result of the lottery, and is not limited to the predetermined time period to the winning user (Step S106). Consequently, the winning user can cause application software for the lottery or other application software to draw the won product with the drawing data of the won product, and display the image of the won product at a timing desired by the user even after a lapse of the predetermined time period. In addition, the delivery instruction unit 26 outputs the instruction for delivering the physical product won as a result of the lottery to the predetermined place corresponding to the user (Step S107). Consequently, the winning user can receive the won product at the predetermined place. Thereafter, the processing shown in the present flowchart is ended.

As described above, as an aspect of the present disclosure, the server device 1a includes the product database 21, the data transmission unit 23, the lottery unit 24, the delivery instruction unit 26, the first authority granting unit 27, and the second authority granting unit 28. Consequently, according to the aspect of the present disclosure, it becomes possible to reduce restrictions on product rollout without spoiling convenience or buying motivation of a consumer.

Second Embodiment

Next, a second embodiment will be described. The description of components and processing details which are the same as those in the first embodiment will be omitted by referring to the first embodiment.

Device Configuration

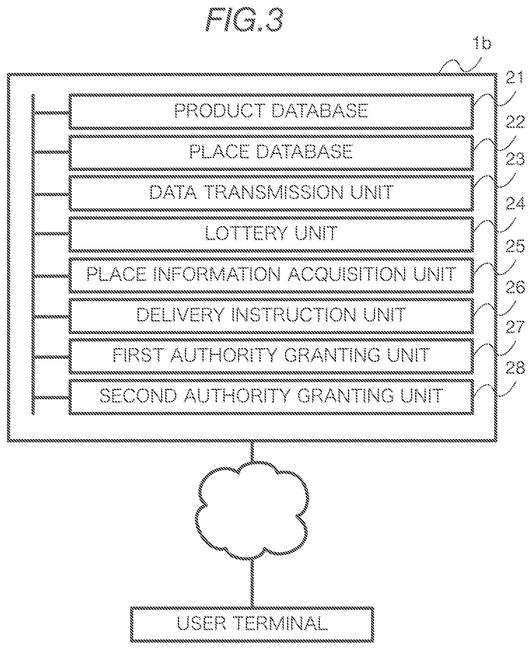

FIG. 3 is a view showing the outline of the functional configuration of a server device 1b according to the present embodiment. In addition to the product database 21, the data transmission unit 23, the lottery unit 24, the delivery instruction unit 26, the first authority granting unit 27, and the second authority granting unit 28 described with reference to FIG. 1 in the first embodiment, the server device 1b according to the present embodiment includes a place database 22 and a place information acquisition unit 25. Further, in the present embodiment, details of processing by the delivery instruction unit 26 are different from the details of the processing described in the first embodiment.

The place database 22 stores information on a place which can be designated as the delivery destination of the product (a facility ID, position information, or an address).

The place information acquisition unit 25 acquires information capable of determining a place where the user has noticed the holding of the lottery (the facility ID of a facility selected by the user, position information of the user terminal, the facility ID determined based on position information on a user terminal side, or an address input by the user) from the user terminal of the user.

In the second embodiment, the delivery instruction unit 26 determines the place where the user has noticed the holding of the lottery from the place database 22 based on the information capable of determining the place which is acquired from the user terminal, and outputs the instruction for delivering the physical product won as a result of the lottery to the determined place.

Processing Procedure

Next, the procedure of processing executed in the present embodiment will be described. Note that the specific details and processing order of the processing shown in a flowchart according to the embodiment are examples for carrying out the present disclosure. The specific processing details and the processing order may be appropriately selected according to the embodiment of the present disclosure.

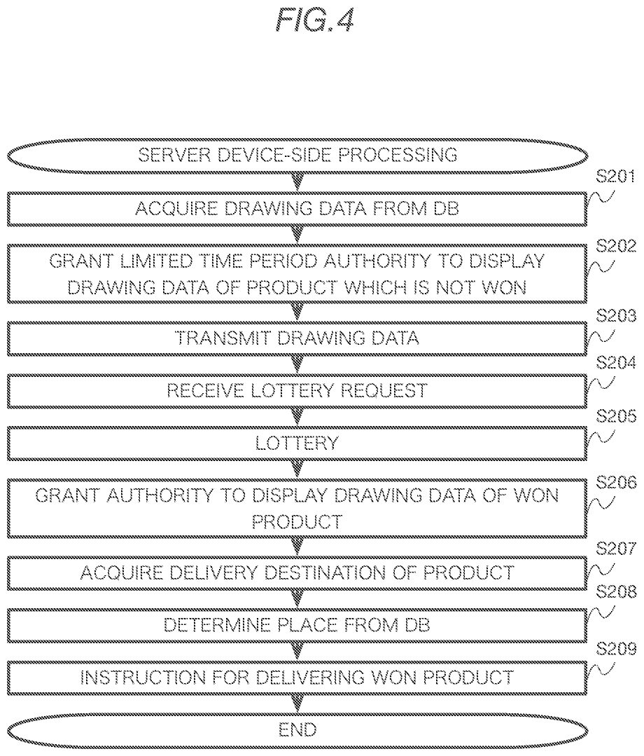

FIG. 4 is a flowchart showing the procedure of the server device-side processing according to the second embodiment. The processing shown in the present flowchart is executed upon reception of the request for the drawing data of the product transmitted by the user terminal.

Processing steps shown from Step S201 to Step S206 are substantially identical to the processing steps from Step S101 to Step S106 described by using FIG. 2, and hence the description thereof will be omitted. Thereafter, the processing proceeds to Step S207.

From Step S207 to Step S209, arrangements for the dispatch of the won product to the place determined based on the information acquired from the user terminal are performed. The place information acquisition unit 25 acquires the information capable of determining the place where the user has noticed the holding of the lottery from the user terminal of the user (Step S207). Note that, in the present embodiment, the information capable of determining the place is acquired from the user terminal at a timing after the lottery, but it is only required that the information is acquired before the delivery instruction of the product, and the acquisition timing of the information is not limited to the example shown in the present flowchart. The delivery instruction unit 26 determines the place from the place database 22 based on the information capable of determining the place which is acquired from the user terminal (Step S208), and outputs the instruction for delivering the physical product won as a result of the lottery to the acquired place (Step S209). Thereafter, the processing shown in the present flowchart is ended.

As described above, as an aspect of the present disclosure, the server device 1b includes the product database 21, the place database 22, the data transmission unit 23, the lottery unit 24, the place information acquisition unit 25, the delivery instruction unit 26, the first authority granting unit 27, and the second authority granting unit 28, and the delivery instruction unit 26 determines the place where the user has noticed the holding of the lottery from the place database 22 based on the information capable of determining the place which is acquired from the user terminal, and outputs the instruction for delivering the physical product won as a result of the lottery to the determined place. Consequently, according to the aspect of the present disclosure, it becomes possible to cause the place where the user has noticed the holding of the lottery (e.g., a store) to match the place to which the won product is delivered (the place where the user receives the won product).

Third Embodiment

Next, a third embodiment will be described. The description of components and processing details which are the same as those in the first embodiment will be omitted by referring to the first embodiment.

Device Configuration

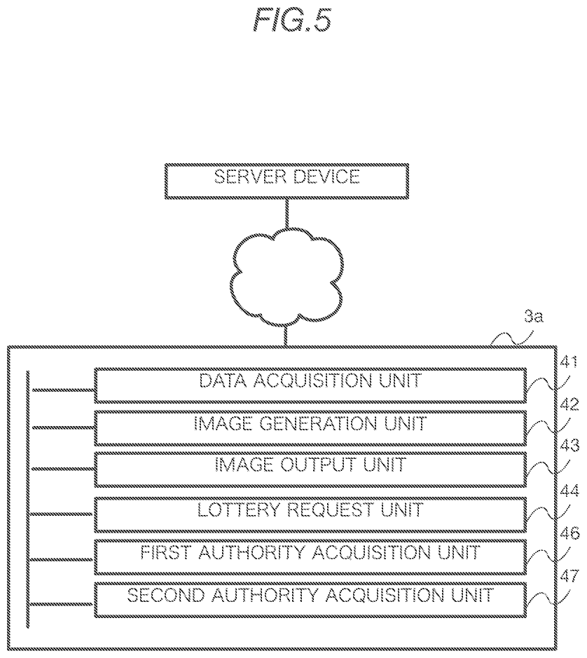

FIG. 5 is a view showing the outline of the functional configuration of a user terminal 3a according to the present embodiment. A processor interprets and executes various programs loaded into various memories, and the user terminal 3a according to the present embodiment thereby functions as an information processing device including a data acquisition unit 41, an image generation unit 42, an image output unit 43, a lottery request unit 44, a first authority acquisition unit 46, and a second authority acquisition unit 47. In the present embodiment, a description will be given of an example in which these functions are executed by a general-purpose processor, but part or all of these functions may also be implemented by one or a plurality of dedicated processors. In addition, the individual functional units provided in the user terminal 3a may be installed remotely and/or in a distributed manner (e.g., on a cloud). Further, these functional units may also be implemented not by a single software module but by a plurality of software modules.

The data acquisition unit 41 acquires identification information of a physical product and drawing data for drawing the product from a server device.

The image generation unit 42 generates an image including a product image drawn based on the drawing data.

The image output unit 43 outputs the image to a display device of the user terminal 3a.

The lottery request unit 44 transmits a lottery request of the product to the server device.

The first authority acquisition unit 46 acquires display authority which relates to the drawing data of a product which is not won, and is limited to a predetermined time period from the server device.

The second authority acquisition unit 47 acquires display authority which relates to the drawing data of a product won as a result of the lottery performed in response to the lottery request, and is not limited to a predetermined time period from the server device.

Processing Procedure

Next, the procedure of processing executed in the present embodiment will be described. Note that the specific details and processing order of the processing shown in a flowchart according to the embodiment are examples for carrying out the present disclosure. The specific processing details and the processing order may be appropriately selected according to the embodiment of the present disclosure.

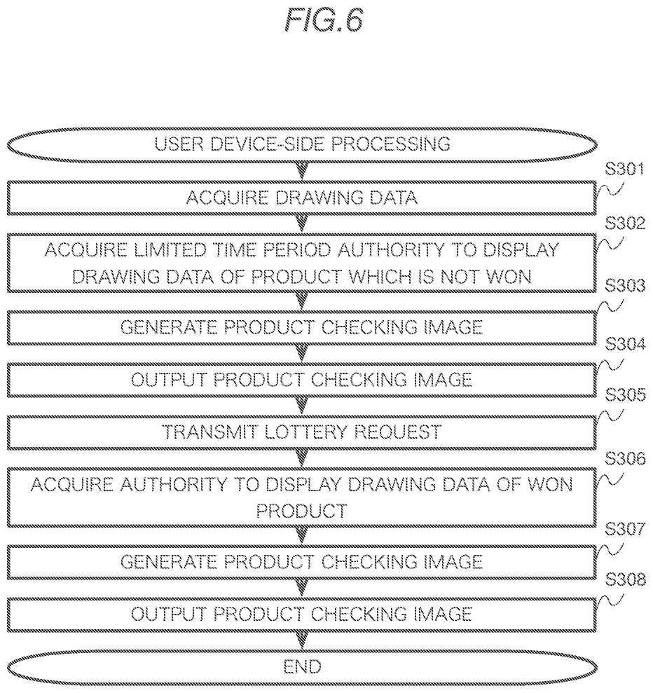

FIG. 6 is a flowchart showing the procedure of user device-side processing according to the third embodiment. The processing shown in the present flowchart is executed upon reception of the drawing data of the product transmitted by the server device.

In Step S301 and Step S302, the drawing data and the display authority which relates to the drawing data are acquired. The data acquisition unit 41 acquires the identification information of the physical product and the drawing data for drawing the product from the server device (Step S301). Subsequently, the first authority acquisition unit 46 acquires the display authority which relates to the drawing data of the product which is not won, and is limited to the predetermined time period from the server device (Step S302). Thereafter, the processing proceeds to Step S303.

From Step S303 to Step S305, an image for reviewing the product is generated and output, and the lottery request is transmitted. The image generation unit 42 generates the image including the product image drawn based on the drawing data (Step S303). Subsequently, the image output unit 43 outputs the image to the display device (Step S304). Consequently, the user can review the product before the lottery with the image. Based on an operation of the user who has reviewed the product with the image, the lottery request unit 44 transmits the lottery request of the product to the server device (Step S305). Thereafter, the processing proceeds to Step S306.

From Step S306 to Step S308, the display authority which relates to the drawing data of the won product is acquired, and the image of the won product is generated and output. The second authority acquisition unit 47 acquires the display authority which relates to the drawing data of the product won as a result of the lottery performed in response to the lottery request, and is not limited to the predetermined time period from the server device (S306). The display authority acquired herein is the display authority which is not limited to the predetermined time period, and hence the winning user can cause application software for the lottery or other application software to draw the won product with the drawing data of the won product (Step S307), and display the image of the won product (Step S308) at a timing desired by the user even after a lapse of the predetermined time period. Thereafter, the processing shown in the present flowchart is ended.

As described above, as an aspect of the present disclosure, the user terminal 3a includes the data acquisition unit 41, the image generation unit 42, the image output unit 43, the lottery request unit 44, the first authority acquisition unit 46, and the second authority acquisition unit 47. Consequently, according to the aspect of the present disclosure, it becomes possible to reduce restrictions on product rollout without spoiling convenience or buying motivation of a consumer.

Fourth Embodiment

Next, a fourth embodiment will be described. The description of components and processing details which are the same as those in the third embodiment will be omitted by referring to the third embodiment.

Device Configuration

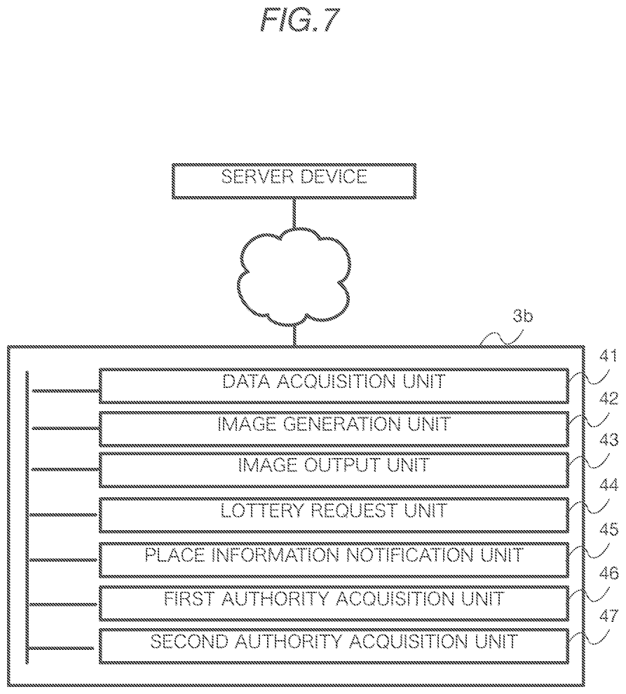

FIG. 7 is a view showing the outline of the functional configuration of a user terminal 3b according to the present embodiment. In addition to the data acquisition unit 41, the image generation unit 42, the image output unit 43, the lottery request unit 44, the first authority acquisition unit 46, and the second authority acquisition unit 47 described with reference to FIG. 5 in the third embodiment, the user terminal 3b according to the present embodiment includes a place information notification unit 45.

The place information notification unit 45 notifies the server device of the information capable of determining the place where the user has noticed the holding of the lottery as information for determining the delivery destination of the physical product in the case where the product is won.

Processing Procedure

Next, the procedure of processing executed in the present embodiment will be described. Note that the specific details and processing order of the processing shown in a flowchart according to the embodiment are examples for carrying out the present disclosure. The specific processing details and the processing order may be appropriately selected according to the embodiment of the present disclosure.

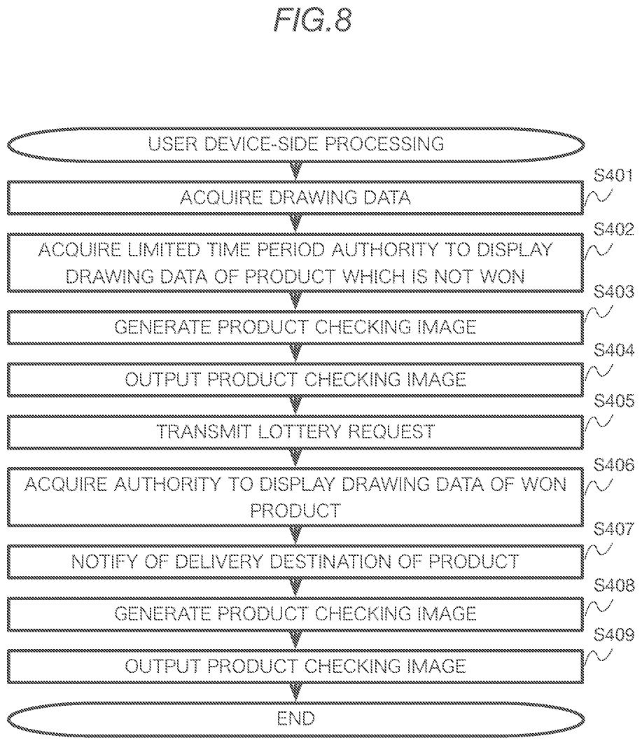

FIG. 8 is a flowchart showing the procedure of the user device-side processing according to file fourth embodiment. The processing shown in the present flowchart is executed upon reception of the drawing data of the product transmitted by the server device.

Processing steps shown from Step S401 to Step S406 are substantially identical to the processing steps from Step S301 to Step S3Q6 described by using FIG. 6, and hence the description thereof will be omitted. Thereafter, the processing proceeds to Step S407.

In Step S407, the delivery destination of the product or information for determining the delivery destination is transmitted. The place information notification unit 45 notifies the server device of the information capable of determining the place where the user has noticed the holding of the lottery as the information for determining the delivery destination of the physical product in the case where the product is won. Thereafter, the processing proceeds to Step S408.

Processing steps shown in Step S408 and Step S409 are substantially identical to the processing steps in Step S307 and Step S308 described by using FIG. 6, and hence the description thereof will be omitted. Thereafter, the processing shown in the present flowchart is ended.

As described above, as an aspect of the present disclosure, the user terminal 3b includes the data acquisition unit 41, the image generation unit 42, the image output unit 43, the lottery request unit 44, the place information notification unit 45, the first authority acquisition unit 46, and the second authority acquisition unit 47. Consequently, according to the aspect of the present disclosure, it becomes possible to cause the place where the user has noticed the holding of the lottery (e.g., a store) to match the place to which the won product is delivered (the place where the user receives the won product).

Fifth Embodiment

### Device Configuration

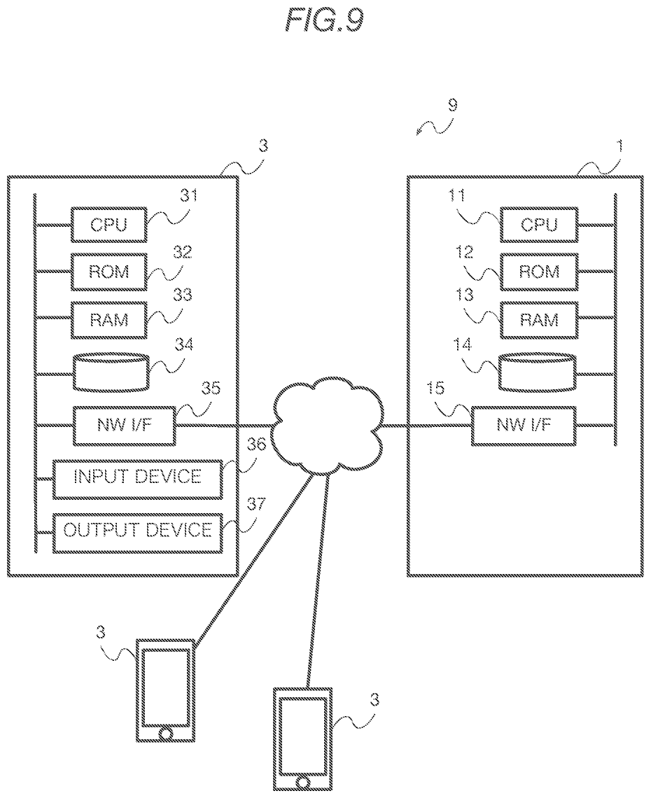

FIG. 9 is a view showing the outline of the configuration of an information processing system 9 according to the present embodiment. The information processing system 9 in the present embodiment has a server device 1 and a plurality of user terminals 3 which are connected to a network such as the Internet. The server device 1 is used for an online lottery service which can be used by the plurality of user terminals 3. Examples of the service provided by the server device 1 include a lottery event for character goods or a character figure, and services to which the technique according to the present disclosure can be applied are not limited to an example shown in the present embodiment. The user terminal 3 is an information processing device used by the user. As the user terminal 3, it is possible to use various types of devices, examples of such devices include a personal computer, a smartphone, a portable game device, a stationary game device, and wearable electronic equipment (e.g., a virtual reality (VR) headset or a smartwatch), and the type of the device is not limited thereto.

The server device 1 is an information processing device in which a central processing unit (CPU) 11, a read only memory (ROM) 12, a random access memory (RAM) 13, an auxiliary storage device 14, and a network interface 15 for performing communication with the outside via a network are connected either by wire or wirelessly. Note that, with regard to the specific hardware configuration of the server device 1, the omission, replacement, and addition of components may be appropriately made according to embodiments.

The CPU 11 controls individual components provided in the server device 1 such as the RAM 13 or the auxiliary storage device 14 by processing commands and data loaded into the ROM 12 and the RAM 13. In addition, the RAM 13 is a main storage device and is controlled by the CPU 11, and various commands and data are written in and read from the RAM 13. That is, the CPU 11, the ROM 12, and the RAM 13 are configured to be a control unit of the server device 1.

The auxiliary storage device 14 is a nonvolatile storage device, and information which is to be retained even when the server device 1 is turned off such as, e.g., an operation system (OS) of the server device 1 loaded into the RAM 13, various programs for executing processing described later, and various pieces of data used by the server device 1 is mainly written in and read from the auxiliary storage device 14. As the auxiliary storage device 14, it is possible to use, e.g., an electrically erasable programmable ROM (EEPROM) or a hard disk drive (HDD).

The user terminal 3 is an information processing device in which a CPU 31, a ROM 32, a RAM 33, an auxiliary storage device 34, a network interface 35, an input device 36, and an output device 37 are connected either by wire or wirelessly. Note that, with regard to the specific hardware configuration of the user terminal 3, the omission, replacement, and addition of components may be appropriately made according to embodiments.

As the input device 36, it is possible to use various devices such as a button, a stick, a keyboard, a mouse, a trackball, a touch sensor, an acceleration sensor, an angular velocity sensor, a camera, a depth sensor, or a microphone. As the output device 37, it is possible to use various devices such as a display device, a speaker, an oscillator, or an LED. In addition, the input device 36 and the output device 37 may also be provided together by using a display with a touch panel.

As the auxiliary storage device 34 of the user terminal 3, in addition to the device described as the auxiliary storage device 14 of the server device 1, a portable medium which is attached detachably may be used. Examples of the portable medium include a card/cartridge-type medium including a ROM or the like, a compact disc (CD), a digital versatile disc (DVD), and a Blu-ray (registered trademark) disc (BD). An auxiliary storage device serving as the portable medium and an auxiliary storage device which is not portable can also be used in combination.

A service (hereinafter referred to as “the present service”) provided by the information processing system 9 disclosed in the present embodiment is an online lottery service which uses AR. In the present service, a user draws online, a product won by lottery is made to order, the product is delivered to a store (e.g., a convenience store) designated by the user after completion of the made-to-order production, and the winning user receives the product at the store. In addition, in a lottery which uses lots, the user selects a lot, checks details of the product using the AR, and performs the lottery. In the case where the product is won as a result of the lottery, the winning user can also receive the display authority which relates to the drawing data allowing the image of the product to be drawn and displayed with the AR, and of which a time period is not limited (e.g., the display authority is maintained as long as the service is continued) only when a product is won for the first time.

Note that, in the present embodiment, a description will be given of an example in which the authority which relates to the drawing data is granted only when a product is won for the first time, but the timing when the authority is granted is not limited to the example shown in the present embodiment. For example, the authority may be granted such that, every time the same product is won, the number of pieces of the drawing data which allows simultaneous AR display is increased. That is, to the user who has won n products which are identical to each other by the lottery, authority allowing n images of the product to be displayed with the AR at the same time may be granted.

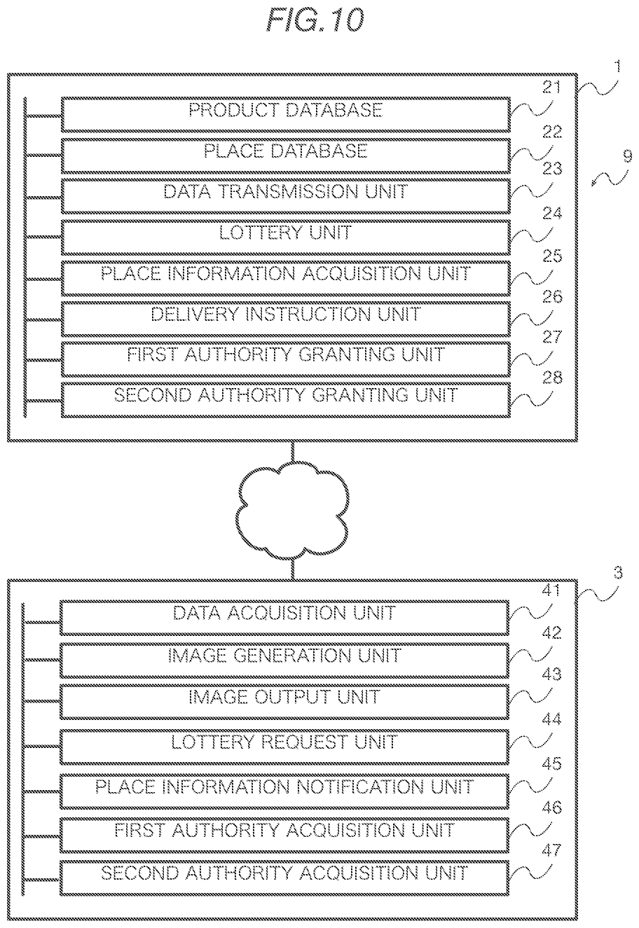

FIG. 10 is a view showing the outline of the functional configuration of the information processing system 9 according to the present embodiment. The CPU 11 interprets and executes various programs loaded into the ROM 12 and the RAM 13, and the server device 1 according to the present embodiment thereby functions as the information processing device including the product database 21, the place database 22, the data transmission unit 23, the lottery unit 24, the place information acquisition unit 25, the delivery instruction unit 26, the first authority granting unit 27, and the second authority granting unit 28. In the present embodiment, a description will be given of an example in which these functions are executed by the general-purpose CPU 11, but part or all of these functions may also be implemented by one or a plurality of dedicated processors. In addition, the individual functional units provided in the server device 1 may also be installed remotely and/or in a distributed manner (e.g., on a cloud). Further, these functional units may also be implemented not by a single software module but by a plurality of software modules.

The product database 21 stores the identification information of the physical product and the drawing data for drawing the product in association with each other. Herein, the drawing data is three-dimensional model data (hereinafter simply referred to as “3D model data”) with which the image when the object is viewed from any direction can be generated by disposing the object in the virtual space and imaging the object with the virtual camera. The drawing data includes data for drawing the product in the augmented reality space.

The place database 22 stores information on the place which can be designated as the delivery destination of the product (a facility ID, position information, and an address). In the present embodiment, a store of a product delivery company is used as the delivery destination of the product, and hence pieces of information such as a store ID, a store name, an address, position information, and a delivery center in charge of the store are stored in association with each store in the place database 22.

The data transmission unit 23 acquires the drawing data from the product database 21 and transmits the drawing data to the user terminal 3.

The lottery unit 24 performs the lottery for the product in response to the lottery request from the user terminal 3. The lottery is performed by, e.g., generating random numbers, and the identifier of the product won as a result of the lottery by the user is output.

The place information acquisition unit 25 acquires the information capable of determining the place where the user has noticed the holding of the lottery (e.g., the facility ID of the facility selected by the user, the position information of the user terminal 3, the facility ID determined based on the position information on the side of the user terminal 3, and the address input by the user) from the user terminal 3 of the user.

The delivery instruction unit 26 determines the place where the user has noticed the holding of the lottery from the place database 22 based on the information capable of determining the place which is acquired from the user terminal 3, and outputs the instruction for delivering the physical product won as a result of the lottery to the determined place. Consequently, in the information processing system 9 according to the present embodiment, it becomes possible to cause the place where the user has noticed the holding of the lottery (e.g., a store) to match the place to which the won product is delivered (the place where the user receives the won product), which serves as an incentive for product promotion at the store which is the place where the holding of the lottery has been noticed.

The first authority granting unit 27 grants the display authority which relates to the drawing data of the product and is limited to the predetermined time period to the non-winning user who has not yet won the product. Herein, the predetermined time period is a time period which includes at least one of a lottery available time period of the product and a lottery notification time period of the product.

The second authority granting unit 28 grants the display authority which relates to the drawing data of the product won as a result of the lottery, and is not limited to the predetermined time period to the winning user. Herein, the display authority which is not limited to the predetermined time period is, e.g., the display authority which is maintained as long as the service is continued and of which the time period is not limited. Note that, as the time period of the display authority granted herein, it is only required that a time period longer than the predetermined time period granted by the first authority granting unit 27 is set, and the time period is not limited to the example in the present disclosure.

The CPU 31 interprets and executes various programs loaded into the ROM 32 and the RAM 33, and the user terminal 3 according to the present embodiment thereby functions as the user terminal 3 including the data acquisition unit 41, the image generation unit 42, the image output unit 43, the lottery request unit 44, the place information notification unit 45, the first authority acquisition unit 46, and the second authority acquisition unit 47. In the present embodiment, a description will be given of an example in which these functions are executed by the general-purpose CPU 31, but part or all of these functions may also be implemented by one or a plurality of dedicated processors. In addition, the individual functional units provided in the user terminal 3 may be installed remotely and/or in a distributing manner (e.g., on a cloud). Further, these functional units may also be implemented not by a single software module but by a plurality of software modules.

The data acquisition unit 41 acquires the identification information of the physical product and the drawing data for drawing the product from the server device 1.

The image generation unit 42 generates, as the image, an augmented reality image in which the product image drawn based on the drawing data is combined with an input image from a camera provided as the input device 36 in the user terminal 3.

The image output unit 43 outputs the image to a display device provided as the output device 37 in the user terminal 3 such as a display with a touch panel.

The lottery request unit 44 transmits the lottery request of the product to the server device 1.

The place information notification unit 45 notifies the server device 1 of the information capable of determining the place where the user has noticed the holding of the lottery as the information for determining the delivery destination of the physical product in the case where the product is won.

The first authority acquisition unit 46 acquires the display authority which relates to the drawing data of the product which is not won, and is limited to the predetermined time period from the server device 1.

The second authority acquisition unit 47 acquires the display authority which relates to the drawing data of the product won as a result of the lottery performed in response to the lottery request, and is not limited to the predetermined time period from the server device 1.

Processing Procedure

Next, the procedure of processing executed in the present embodiment will be described. Note that the specific details and processing order of the processing shown in the embodiment are examples for carrying out the present disclosure. The specific processing details and the processing order may be appropriately selected according to the embodiment of the present disclosure.

First, the user who uses the present service notices a lottery event provided by the present service in a predetermined store (a store serving as a place where the product of the present service is received). In the lottery event, for example, character goods licensed from a right owner who owns intellectual property rights related to a predetermined character are provided via the lottery. When the user notices the lottery event, the user activates application software (may be dedicated application software or may also be general-purpose software such as a Web browser) for using the present service which is installed in the user terminal 3, and selects a desired lottery event from the list of the lottery event (a plurality of lottery events may be provided at the same time) displayed on the top page (home page). When the lottery event is selected, a product lineup including one or a plurality of types of products which can be won in the case where the lottery is performed in the selected lottery event is displayed in the user terminal 3. The user checks the product lineup displayed in the user terminal 3.

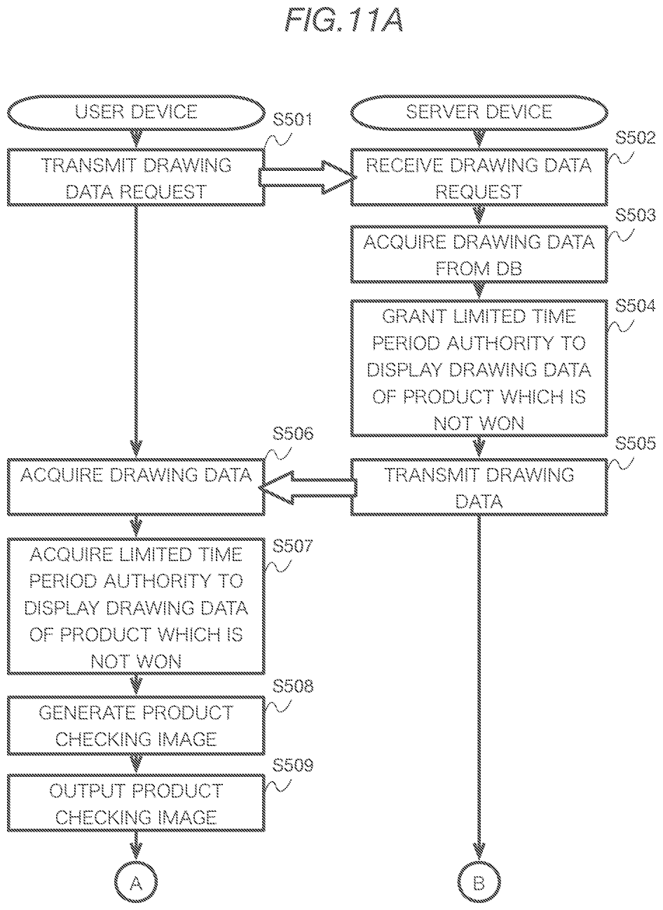

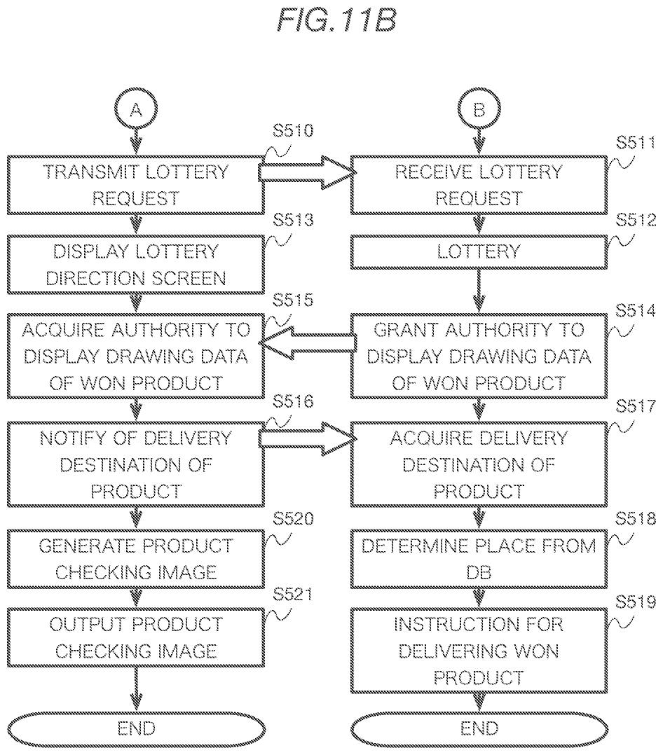

FIGS. 11A and 11B are sequence diagrams showing the procedure of lottery event processing according to the fifth embodiment. The processing shown in the sequence diagram is executed upon selection of any product from the displayed product lineup by the user in the user terminal 3.

From Step S501 to Step S507, granting of the display authority which relates to the drawing data and data transmission are performed from the server device 1 to the user terminal 3. In the present embodiment, the drawing data which allows the image of the product to be drawn and displayed with the AR and the display authority which allows drawing and display of the drawing data only for the purpose of reviewing the product during the lottery event are given to the user terminal 3. When the user selects any product from the product lineup displayed in the user terminal 3, the user terminal 3 transmits a data request for data on the selected product to the server device 1 (Step S501). When the data request is received by the server device 1 (Step S502), the data transmission unit 23 acquires the identification information of the physical product and the drawing data of the product from the product database 21 (Step S503), and the first authority granting unit 27 grants the display authority which relates to the drawing data of the product and is limited to the predetermined time period to the non-winning user (Step S504). Subsequently, the server device 1 transmits the identification information of the product, the drawing data, and the information for granting the display authority to the user terminal 3 (Step S505).

The data acquisition unit 41 of the user terminal 3 receives the identification information of the product, the drawing data for drawing the product, and the information for granting the display authority which relates to the drawing data which are transmitted from the server device 1 (Step S506), and the first authority acquisition unit 46 acquires the display authority which relates to the drawing data of the product which is not won, and is limited to the predetermined time period based on the received information (Step S507). Thereafter, the processing proceeds to Step S508.

In Step S508 and Step S509, an image for reviewing the product is generated and output. The image generation unit 42 generates the image including the product image drawn based on the drawing data (Step S508). Subsequently, the image output unit 43 outputs the image to the display device (Step S509). Thereafter, the processing proceeds to Step S510.

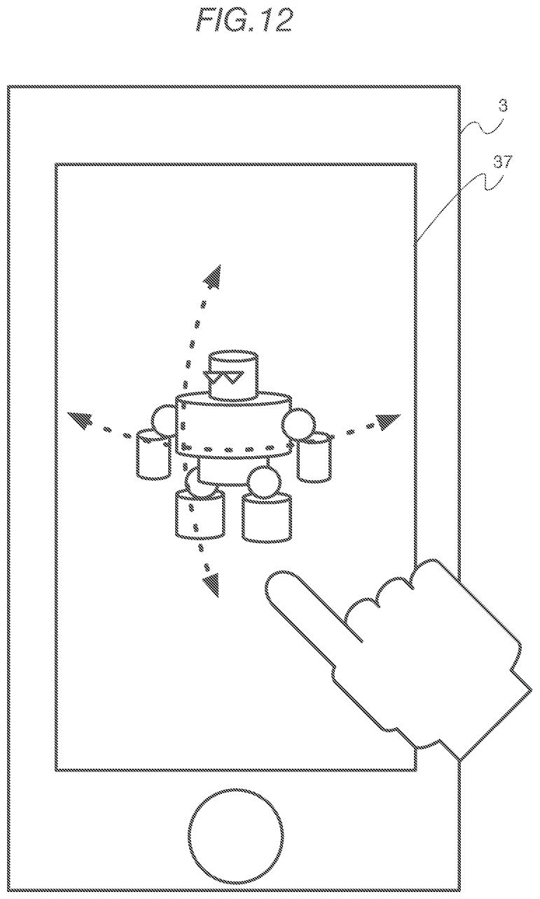

FIG. 12 is a view showing an example of the user terminal 3 in which the image (rotatable display screen) is displayed. In the present embodiment, a product review screen including a 3D image of the product which can be rotated in all directions and displayed according to user input to a touch sensor, an acceleration sensor, and an angular velocity sensor is displayed in the user terminal 3 based on the downloaded drawing data and display authority. Note that arrows in a broken line in the drawing indicate that the 3D image of the product can be rotated in all directions in response to the user input.

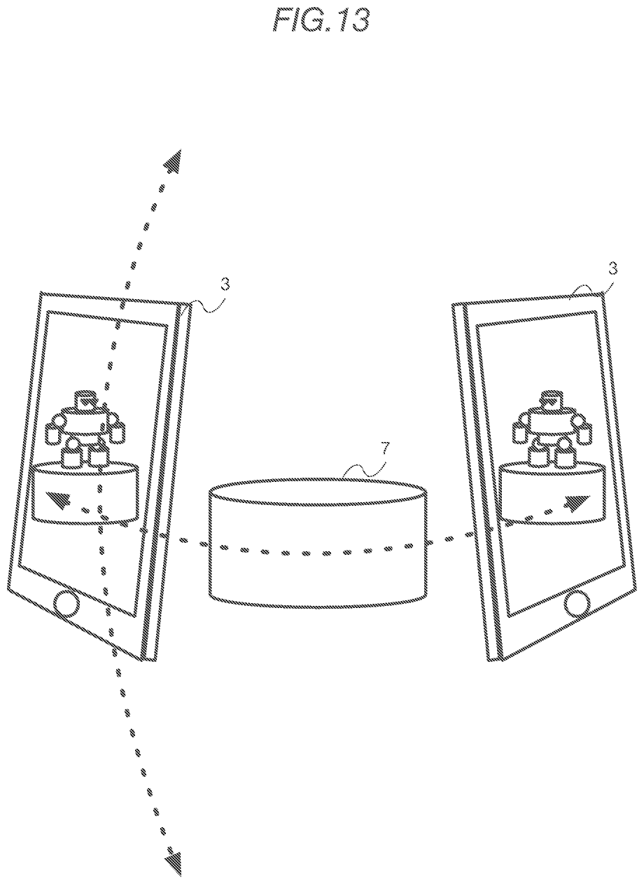

FIG. 13 is a view showing an example of the user terminal 3 in the present embodiment in which the image (AR display screen) is displayed. When the user selects AR display in the product review screen, the product review screen based on the AR in which the 3D image of the product is combined with a camera input image of the user terminal 3 is displayed. Herein, the user terminal 3 sets a coordinate system in a real space imaged by a camera based on inputs from an acceleration sensor, an angular velocity sensor, and a depth sensor provided in the user terminal 3, causes the movement of the camera in the virtual space to follow the movement of the camera in the real space by causing the coordinate system in the real space to match a coordinate system in the virtual space in which the 3D image of the product is drawn, and generates an AR image in which the 3D image of the product is combined with the camera input image such that the product looks as if the product were actually disposed in the real space. With this, the user can check details and a sense of realism of the product (e.g., the appearance of the product in the case where the product is actually placed on a desk 7 of the user) which cannot be obtained from a mere product photograph before the lottery. Note that arrows in a broken line in the drawing indicate the movement of the user terminal 3 detected by various sensors. According to FIG. 13, it can be seen that the 3D image of the product can be observed from various angles as if the actual product were placed on the desk 7 according to the position and the attitude of the user terminal 3.

In Step S510, the lottery request is transmitted. In the case where the user having checked the product desires to perform the lottery, the user can perform a lottery instruction via the user terminal 3. At this point, in the case where the user has already logged in with an account associated with settlement means, the screen proceeds to a lottery screen. On the other hand, in the case where the user has not logged in, a login/user registration screen is displayed, and login or user registration is performed. Note that, as login means, it is possible to use various means such as biometric authentication in addition to means for inputting a user name and a password, and the login means is not particularly limited. Subsequently, in the user terminal 3, the user inputs the number of times of the lottery (the number of times of lot) in the selected lottery event, and inputs the lottery instruction. Based on an operation by the user having checked the product with the image, the lottery request unit 44 transmits the lottery request of the product to the server device 1. Thereafter, the processing proceeds to Step S511.

In Step S511 and Step S512, the lottery for the product is performed. When the lottery request (including the number of times of the lottery) transmitted from the user terminal 3 is received (Step S511), the lottery unit 24 of the server device 1 performs the lottery for the product the number of times specified by the number of times of the lottery (Step S512). Note that the lottery performed by the lottery unit 24 may be a lottery in which any product is always won or may also be a lottery in which the product may not be won. In the case where no product is won by the lottery, the processing is ended. In the case where any product is won by the lottery, the processing proceeds to Step S514.

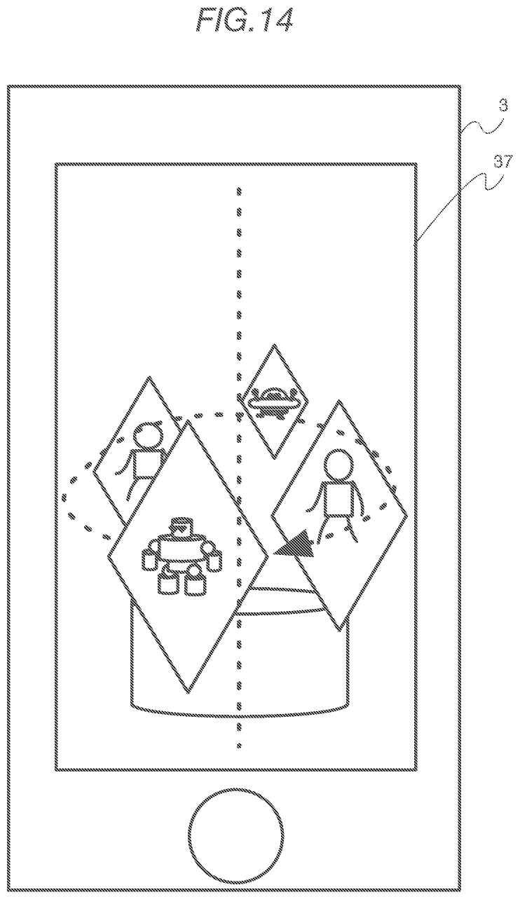

FIG. 14 is a view showing an example of the user terminal 3 in which a lottery direction screen according to the present embodiment is displayed. When the lottery instruction is transmitted from the user terminal 3 to the server device 1, the user terminal 3 displays a directed image of the lottery (Step S513). In the present embodiment, there is displayed the directed image in which an image in which an object (may also be a 3D graphics of products) having photographs of a plurality of products which may be won in the lottery event rotates about an axis provided in the center of the screen (see a vertical axis in a broken line in the drawing) is combined with an image of the real space input from the camera of the user terminal 3. Note that an arrow in a broken line in the drawing indicates that a plurality of product images are displayed while being rotated. After the display of the directed image, the user terminal 3 displays information on a won product according to a lottery result received from the server device 1.

In Step S514 and S515, the display authority which relates to the drawing data of the won product is granted from the server device 1 to the user terminal 3. In the present embodiment, when a product is won for the first time, the display authority which allows drawing and display of the drawing data of the won product and of which the time period is not limited (e.g., the display authority is maintained as long as the service is continued) is granted to the user. When the product is won as a result of the lottery, the second authority granting unit 28 grants the display authority which relates to the drawing data of the product won as a result of the lottery, and is not limited to the predetermined time period to the winning user (Step S514). The second authority acquisition unit 47 acquires the display authority which relates to the drawing data of the product won as a result of the lottery performed in response to the lottery request, and is not limited to the predetermined time period from the server device 1 (Step S515). Consequently, the user can download the drawing data of the won product to the user terminal 3 of the user, and draw, display, and enjoy the image of the won product with the AR. Thereafter, the processing proceeds to Step S516.

In Step S516, the delivery destination of the product or the information for determining the delivery destination is transmitted from the user terminal 3 to the server device 1. The user terminal 3 causes my page associated with the account of the user to be displayed, and causes the user to register receipt information of the product. In the present embodiment, the receipt information includes a user name and a receipt store of the product. The user inputs the user name via the input device 36 of the user terminal 3, and further selects the receipt store of the product. The place information notification unit 45 transmits the information (e.g., the store ID of the store selected by the user, the position information of the user terminal 3, the store ID determined based on the position information on the side of the user terminal 3, or the store ID determined based on the address input by the user) capable of determining the place where the user has noticed the holding of the lottery (the store in the present embodiment) to the server device 1 as the information for determining the delivery destination of the physical product in the case where the product is won. Thereafter, the processing proceeds to Step S517.

From Step S517 to Step S519, production of the won product and arrangements for the dispatch of the product are performed. The place information acquisition unit 25 of the server device 1 receives the information capable of determining the place where the user has noticed the holding of the lottery (the store in the present embodiment) from the user terminal 3 of the user (Step S517). Note that, in the present embodiment, the information capable of determining the place is acquired from the user terminal 3 at a timing after the lottery, but it is only required that the information is acquired before the delivery instruction of the product, and the acquisition timing of the information is not limited to the example shown in the present disclosure. When the receipt information of the product is registered by the user, the server device 1 performs the production of the product and arrangement processing for the delivery. The delivery instruction unit 26 determines the place (store) from the place database 22 based on the information capable of determining the place acquired from the user terminal 3 (Step S518), and outputs the instruction for delivering the physical product won as a result of the lottery to the determined place (store) (Step S519). Consequently, the winning user can receive the won product at the predetermined place.

Note that the display authority acquired in Step S515 is the display authority which is not limited to the predetermined time period. Consequently, the user can cause application software for the lottery or other application software to draw the won product with the drawing data of the won product (Step S520), and display the image of the won product (Step S521) at a timing desired by the user even after a lapse of the predetermined time period. At this point, as software and a system for drawing and displaying of the drawing data to which the display authority is granted, software and a system different from software and a system for the present online lottery service may be used. Note that the image displayed herein is substantially identical to the image described by using FIG. 12 and FIG. 13, and hence the description thereof will be omitted.

The service according to the present embodiment is provided by a system providing company, a product providing company, and a product delivery company on a conjoint basis. The system providing company handles service development and user inquiries, the product providing company provides a product and the IP of the product, and the product delivery company handles product delivery to a store chain which can be designated by the user. In the present embodiment, the lottery performed by the user and the settlement of payment for a product are performed in the server device 1 which is managed and operated by the system providing company, and customer support for the user is also performed by the system providing company. In addition, the product providing company performs the production and shipment of the product. Further, the product delivery company delivers the product delivered from the product providing company to the delivery destination (in the present embodiment, a store belonging to the store chain operated by the product delivery company) designated by the user from a distribution center of the product delivery company, and gives the product to the user at the store. Note that the provision mode of the service described in the present embodiment is an example when the technique according to the present disclosure is carried out, and is not limited to the example described in the present embodiment.

According to the information processing system 9 of the present embodiment, the made-to-order production of the product is allowed, and hence the service provider or the store does not need inventory. In addition, the user can check the product as if the actual product were present with the AR, and hence it is not necessary to display the product in the store. Consequently, according to the information processing system 9 of the present embodiment, it becomes possible to easily provide even a relatively large product. Further, it is not necessary to display the product in the store and it is not necessary to install equipment for the lottery in the store, and hence it is possible to perform promotion of the product (e.g., a press release, notification on a magazine board in the store, POS register advertisement, and a broadcast in the store. Note that the promotion may also be joint promotion by the system providing company, the product providing company, and the product delivery company,) in many stores.

Other Variations

Each embodiment described above shows an example in the case where the present disclosure is carried out, and the present disclosure is not limited to the specific configurations described above. When the present disclosure is carried out, the specific configuration corresponding to the embodiment may be appropriately adopted.

In each embodiment described above, the user can make the lottery request at any place where the user can communicate with the server device via a network after the user has noticed the holding of the lottery. Note that the place where the user can make the lottery request by using the user terminal may be limited. For example, only in the case where it can be determined that the user terminal is at a predetermined place (e.g., a place near a store which can be designated as the delivery destination of the product) based on the position information or a predetermined beacon (a signal of a wireless LAN or the like) acquired by the user terminal, the lottery is allowed. With this, it becomes possible to relate the place where the user notices the holding of the lottery, the place where the lottery is performed, and the place where the product is received to each other more closely. Note that a determination of whether or not the lottery is allowed based on the position information or the like may be performed by the user terminal or may also be performed by the server device having received the position information or the like from the user terminal.

What is claimed is:

1. A server device comprising:
a product database configured to store identification information of a physical product and drawing data for drawing the product in association with each other;
a memory; and
a processor coupled to the memory, the processor being configured to execute:
acquiring the drawing data from the product database and transmitting the drawing data to a user terminal;
granting first display authority to display the drawing data of the product to a non-winning user who does not win the product, the first display authority limited to a predetermined time period;
performing a lottery for a product in response to a lottery request from the user terminal;
outputting an instruction for delivering a physical product won as a result of the lottery to a predetermined place corresponding to a user; and
granting second display authority to display the drawing data of the product won as a result of the lottery to a winning user, the second display authority not limited to the predetermined time period.

2. The server device according to claim 1, wherein the drawing data includes data for drawing the product in an augmented reality space.

3. The server device according to claim 1, wherein the predetermined time period includes at least one of a lottery available time period of the product and a lottery notification time period of the product.

4. The server device of claim 1, further comprising:
a place database configured to store information on a place which can be designated as a delivery destination of the product,
wherein the processor further configured to execute acquiring information from the user terminal of the user, the information enabling the processor to determine a place where the user noticed the lottery, and
wherein the processor is configured to determine the place where the user noticed the lottery from the place database on the basis of the information acquired from the user terminal, and further configured to output the instruction for delivering the physical product won as a result of the lottery to the determined place.

5. A non-transitory computer-readable recording medium having recorded thereon a program for causing a computer connected to a display device to execute:
acquiring, from a server device, identification information of a physical product and drawing data for drawing the product;
acquiring, from the server device, first display authority to display the drawing data of a product which is not won, the first display authority limited to a predetermined time period;
generating a image including a product image drawn on the basis of the drawing data;
outputting the image to the display device;
transmitting a lottery request of the product to the server device; and
acquiring, from the server device, second display authority to display the drawing data of a product won as a result of a lottery performed in response to the lottery request, the second display authority not limited to the predetermined time period.

6. The non-transitory computer-readable recording medium having recorded thereon the program according to claim 5, wherein
the computer is further connected to a camera, and
the computer is configured to generate an augmented reality image in which the product image drawn on the basis of the drawing data is combined with an input image from the camera as the image.

7. The non-transitory computer-readable recording medium having recorded thereon the program according to claim 5, further causing the computer to execute notifying the server device of information enabling the server device to determine a place where a user noticed the lottery, as information for determining a delivery destination of a physical product when the product is won.

8. A method for a computer including a product database that is configured to store identification information of a physical product and drawing data for drawing the product in association with each other, the method comprising:
acquiring the drawing data from the product database and transmitting the drawing data to a user terminal by the computer;
granting first display authority to display the drawing data of the product to a non-winning user who does not win the product, the first display authority limited to a predetermined time period;
performing a lottery for a product in response to a lottery request from the user terminal;
outputting an instruction for delivering a physical product won as a result of the lottery to a predetermined place corresponding to a user; and
granting second display authority to display the drawing data of the product won as a result of the lottery to a winning user, the second display authority not limited to the predetermined time period.

9. A non-transitory computer-readable recording medium having recorded thereon a program for causing a computer including a product database configured to store identification information of a physical product and drawing data for drawing the product in association with each other to execute:
acquiring the drawing data from the product database and transmitting the drawing data to a user terminal;
granting first display authority to display the drawing data of the product to a non-winning user who does not win the product, the first display authority limited to a predetermined time period;
performing a lottery for a product in response to a lottery request from the user terminal;
outputting an instruction for delivering a physical product won as a result of the lottery to a predetermined place corresponding to a user; and
granting second display authority to display the drawing data of a product won as a result of the lottery to a winning user, the second display authority not limited to the predetermined time period.
